(19) United States
(12) Patent Application Publication
(10) Pub. No.: US 2024/0281805 A1
(43) Pub. Date: Aug. 22, 2024

(54) Trusted Service for Storage and Distribution of Personalized Assets for Use with 3rd Party Applications

(71) Applicant: TENCENT AMERICA LLC, Palo Alto, CA (US)

(72) Inventors: Arianne HINDS, Palo Alto, CA (US); Stephan WENGER, Hillsborough, CA (US)

(73) Assignee: TENCENT AMERICA LLC, Palo Alto, CA (US)

(21) Appl. No.: 18/440,813

(22) Filed: Feb. 13, 2024

Related U.S. Application Data
(60) Provisional application No. 63/446,279, filed on Feb. 16, 2023.

(51) Int. Cl. G06Q 20/38

(52) U.S. Cl. CPC G06Q 20/389; G06Q 2220/18

(57) ABSTRACT

This disclosure generally relates to architectures, structures and components for systems and networks that distribute media, and is particularly directed to provisioning of personalized media content to heterogenous networked applications. For example, methods and systems for storage, management, and distribution of personalized digital assets may be provided as a service to user and a heterogeneous set of applications. Such a service may be provided to applications in a secure manner and the distribution of the personal digital assets may be protected by digital right management schemes. Such digital assets may be used in an agnostic manner within or across independent applications or platforms with user authorization, thereby providing a consistent and unified experiences associated with these personalized digital assets.

### INCORPORATION BY REFERENCE

This disclosure is based on and claims the benefit of priority to U.S. Provisional Application No. 63/446,279, entitled “TRUSTED SERVICE FOR STORAGE AND DISTRIBUTION OF PERSONALIZED ASSETS FOR USE WITH 3RD PARTY APPLICATIONS,” filed on Feb. 16, 2023, which is herein incorporated by reference in its entirety.

### TECHNICAL FIELD

This disclosure generally relates to architectures, structures and components for systems and networks that distribute media, and is particularly directed to provisioning of personalized media content to heterogenous networked applications.

### BACKGROUND

Digital media assets such as user avatars are platform specific. For example, digital assets of a user in each virtual world platform for providing immersive metaverse experience or in other online applications do not exist outside of that particular virtual world platform or online application. At the same time, at least some types of digital assets may be of generality to a user. As such, it may be desirable to decouple these types of digital assets with a particular application or platform.

### SUMMARY

This disclosure generally relates to architectures, structures and components for systems and networks that distribute media, and is particularly directed to provisioning of personalized media content to heterogenous networked applications. For example, methods and systems for storage, management, and distribution of personalized digital assets may be provided as a service to user and a heterogeneous set of applications. Such a service may be provided to applications in a secure manner and the distribution of the personal digital assets may be protected by digital right management schemes. Such digital assets may be used in an agnostic manner within or across independent applications or platforms with user authorization, thereby providing a consistent and unified experiences associated with these personalized digital assets.

In some example implementations, a method for providing a personalized digital asset as a service by a trusted circuitry to a heterogenous set of independent applications is disclosed. The method may include receiving the personalized digital asset generated in a common format; storing the personalized digital asset off a blockchain system; and distributing the personalized digital asset with a usage right restriction to any application among the heterogenous set of independent applications when the personalized digital asset is requested by the application and is electronically authorized by an owner of the personalized digital asset, the usage right restriction being provisioned under at least one digital right management scheme.

In the example implementation above, the personalized digital asset comprise an 3D avatar created by the owner.

In any one of the example implementations above, the usage right restriction is configured to prohibit a duplication of the distributed personalized digital asset or a redistribution of the personalized digital asset to other applications.

In any one of the example implementations above, distributing the personal digital asset is performed in the blockchain system.

In any one of the example implementations above, the usage right restriction is configured to enforce a usage time expiration condition of the distributed personalized digital asset.

In any one of the example implementations above, the method may further include receiving an augmenting digital asset that is combinable with the personalized digital asset, the augmenting digital asset being provided by the application for augmenting the personal digital asset; and storing the augmenting digital asset off the blockchain system.

In any one of the example implementations above, the method may further include providing the augmenting digital asset for combination with the personalized digital asset for usage in another application among the heterogenous set of independent applications.

In any one of the example implementations above, the application is an online retail store comprising a virtual dressing room and 3D digitization of a plurality of items being sold.

In any one of the example implementations above, the application is an online retail store, and the method may further include distributing the personalized digital asset to a second application among the heterogenous set of independent applications when the personalized digital asset is requested by the second application and is electronically authorized by the owner of the personalized digital asset, the second application being a virtual world application.

In any one of the example implementations above, the heterogeneous set of independent applications comprise at least one real-world application and at least one virtual world application; and the personalized digital asset is provisioned by the trusted circuitry to both the at least one real-world application and the at least one virtual world application.

In any one of the example implementations above, the heterogeneous set of independent applications comprise at least two distinct virtual world applications; and the personalized digital asset is provisioned by the trusted circuitry for use in both of the at least two distinct virtual world applications.

In some other example implementation, a system is disclosed for providing a personalized digital asset as a service by a trusted circuitry to a heterogenous set of independent applications. The system may include a memory for storing computer instructions and a processor configured to execute the computer instructions to perform any one of the methods above.

In some other example implementations, non-transitory computer-readable medium is disclosed for storing computer instructions, for providing a personalized digital asset as a service by a trusted circuitry to a heterogenous set of independent applications according to any one of the methods above.

### BRIEF DESCRIPTION OF THE DRAWINGS

Further features, the nature, and various advantages of the disclosed subject matter will be more apparent from the following detailed description and the accompanying drawings in which:

FIG. 1 shows an example entity relationships diagram depicting relationships between a user client, application service, trusted service, secured asset database, and application database in a system for providing personalized digital assets.

FIG. 2 shows a schematic illustration of an example data flow between the entities depicted in FIG. 1 for the purpose of transferring the secured assets to an application.

FIG. 3 shows a schematic illustration of an example data flow between the entities depicted in FIG. 1 for purposes of transferring the secured assets from the user to the trusted service.

FIG. 4 shows an example sequence diagram depicting interactions between the user, application, and the trusted service with respect to personalized digital assets for a virtual dressing room use case.

FIG. 5 shows a functional diagram for utilizing the personalized digital assets for the virtual dressing room use case of FIG. 4.

FIG. 6 illustrates an example system diagram of a computer system that can be used as components for implementing the digital assets provisioning system above.

### DETAILED DESCRIPTION OF EMBODIMENTS

Throughout the specification and claims, terms may have nuanced meanings suggested or implied in context beyond an explicitly stated meaning. The phrase “in one embodiment/implementation” or “in some embodiments/implementations” as used herein does not necessarily refer to the same embodiment/implementation and the phrase “in another embodiment/implementation” or “in other embodiments” as used herein does not necessarily refer to a different embodiment. It is intended, for example, that claimed subject matter includes combinations of exemplary embodiments/implementations in whole or in part.

In general, terminology may be understood at least in part from usage in context. For example, terms, such as “and”, “or”, or “and/or,” as used herein may include a variety of context-dependent meanings. Typically, “or” if used to associate a list, such as A, B or C, is intended to mean A, B, and C, here used in the inclusive sense, as well as A, B or C, here used in the exclusive sense. In addition, the term “one or more”, “at least one”, “a”, “an”, or “the” as used herein, depending at least in part upon context, may be used in a singular sense or plural sense. In addition, the term “based on” or “determined by” may be understood as not necessarily intended to convey an exclusive set of factors and may, instead, allow for existence of additional factors not necessarily expressly described, again, depending at least in part on context.

The computer readable media can have computer code thereon for performing various computer-implemented operations. The media and computer code can be those specially designed and constructed for the purposes of the present disclosure, or they can be of the kind well known and available to those having skill in the computer software arts.

While this disclosure has described several exemplary embodiments, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

In the disclosure below, “Immersive experiences” may be used to refer to human interaction with media and or devices (that can ingest and support such media), to collectively stimulate any or any one, some of, or all of human sensory systems (visual, auditory, somatosensory, olfactory, and possibly gustatory) to create or enhance the perception of the human user being physically present in the experience created by the media (and/or media along with actuators of the corresponding devices) beyond what would be capable in the user's current real-world or natural environment; i.e., without such devices and media. Examples of immersive experiences include but are not limited to those enabled by applications for Augmented Reality, Virtual Reality, or Holographic imagery with or without sound, haptics, and olfactory stimuli. The visual, audio, and other perceptions in immersive experiences may generally be adapted in real-time to user orientation, motion, and the like in order to provide a perception of immersion. In general, these experiences exceed the capabilities of media created solely for presentation by two dimensional (2D) displays and related applications.

An example of “immersive experiences” includes online virtual world experiences enabled by emerging platforms such as Meta Platforms' Horizon Worlds. In this example, individual users may create and publish virtual worlds, using build or creation tools provided by such platforms, in which other users may be invited to engage and interact in real time. The virtual worlds may consist of objects that are built from a menu of options including geometric shapes, surface properties (e.g., colors, reflectivity to light, visual texture, touching texture, and the like), sounds, animation capabilities, and kinetic properties, (e.g., what should happen if a user collides with a particular object). Likewise, individual users may create their own personalized avatars that represent how the user appears, sounds, and interacts with other users in the virtual world. Avatars may be designed to be consistent with the user's real-world appearance, or likewise designed to portray an imaginary persona. To a person having ordinary skill in the art, objects such as those comprised in a virtual world, or the entire virtual world itself, and or the avatars that serve to capture the identify of individual users, may be regarded as digital assets where such assets may be created and stored in one or more computer files.

Users in the virtual worlds may collaborate or compete via their avatars to evolve or participate in such worlds for any number of purposes, goals, collaborations, competitions, or other scenarios that may have corollaries in the real world. An important aspect of these virtual worlds is that they persist over time until such time that the virtual world is explicitly destroyed. Accordingly, each world, and each actor (avatar) within the world has associated with it, its own state. As in the case of Meta Platforms Horizon Worlds, the current state of each avatar or virtual world may be captured and maintained by the specific platform (e.g., Horizon World) so that users may enter and exit each world, and a timeline of events is preserved and captured by the current state of the world or avatar such that it is consistent with the passage of time within the virtual world.

In the above example of online virtual worlds, it may be worthy to note that each of the individual assets that is comprised in a virtual world, and or the individual avatars themselves, are stored within and owned by the platform in which they are used. For example, users of the Horizon Worlds platform may create their personalized avatars, virtual worlds, and the objects comprised within such virtual worlds. Their avatars may interact with other avatars, enter, exit, and or participate in virtual worlds that are stored and managed within the Horizon Worlds platform.

However, users may not be able to export the assets including but not limited to their avatars that they create within the Horizon Worlds platform for use in another online platform. In other words, the digital assets that are used within the Horizon Worlds platform may not be able to be exported so that they may be used in other 3^{rd} party applications. The assets so created are not agnostic and thus cannot traverse across distinct virtual world platforms. While particular virtual world platforms (such as Horizon World) are mentioned above or in the disclosure below, they are merely referred to as examples, and the applicability of the principles underlying the various implementations disclosed herein are not so limited.

An extension of the above scenario within immersive experiences in virtual world platforms may be to permit users to import and export objects, or digital assets that users separately and/or independently create and own, for use in any one of a plurality of virtual world platforms which are maintained and managed by a heterogeneous collection of virtual world platform service providers. Such separately created digital assets would include but not limited to digital avatar of the users themselves. In other words, such digital assets may then be used in immersive experiences such as in the virtual world described above, but across different virtual world or metaverse platforms. Each of the virtual world platforms may then be configured to ingest these digital assets for use in the immersive experiences provided by that virtual world platform. For example, each of the plurality of virtual world platforms may be standardized and configured to import and render a separately created and managed avatar of a user as a representation of the user in its virtual world to provide immersive experiences for the user, and the user would appear the same in each independent virtual world platform. For another example, digitized version of other user properties (such as the user's house, clothes, and other properties) may also be imported or used in any one of the virtual world platforms in a consistent manner.

Merely as an example, an avatar of a user as a one type of privately managed digital asset may be created in various manners to represent a user's likeness. For example, a variety of means to capture, record, and store a user's likeness may be implemented. The user's likeness may be stored in a two-dimensional representation (e.g., still image or video) or synthesized into three dimensional formats including, e.g., point clouds and/or geometric meshes. With respect to the ability to enable immersive experiences on immersive media-capable devices, the 3D formats, in particular, are better equipped to represent a user's likeness because such formats are capable of storing more information about the user, e.g., the user's complete geometry including stature and shape. These formats may furthermore be able to store properties about the user's appearance such as how the user's skin reacts to various lighting conditions. That is, when these formats are rendered in different lighting environments, photo-realistic results (e.g., consistent with the physical world) may be achieved. Hence, as these formats may facilitate storage of significant and much more dense information about the user's likeness, e.g., beyond what can be stored in a two-dimensional format, they are even more likely to be suitable as a means to establish a user's identity or likeness.

One example method of capturing a user's likeness to create a three-dimensional representation is by first recording a series of mobile images of the user from different angles. These images are then registered along a grid so as to align the images with information regarding the precise angle and viewpoint captured of the user. The angular information and images are then processed by, for example, one or more neural networks (a form of artificial intelligence), to synthesize the images into a 3D representation. An example of such a technique may be referred to as Neural Radiance Fields, or simply, NeRF. The NeRF technique may be one of many example technologies that have been and are being developed whereby real-world imagery of a user (or object) is captured from multiple viewpoints in order to synthesize a 3D representation of the user (or other objects).

Alternative or in addition to user's likeness (avatar), other personalized digital assets may include, for example, 3D representation of other personal objects, e.g., users' homes, cars, children. Such collection of 3D representations may be regarded as personal digital assets that are owned by a particular user, about which the user may desire to secure from online fraud or theft,

Beyond virtual world or metaverse usage described above, another extension of the usage of user created managed digital assets such as the avatars and other personal assets above would be for their use across a diverse collection of general applications. These applications may or may not be related to a virtual world platform. Further, these applications may or may not involve immersive experiences. As such, while each virtual world platform may be considered as an application that utilizes various personalized digital assets, the term “application” as used in this disclosure should be broadly interpreted.

For example, some of these applications may be developed for purposes other than Virtual world platform experiences. Rather, they may be developed for usages more closely aligned with real world use cases and scenarios that may nevertheless take advantage of and utilize such personalized digital assets described above, including the digital avatars. Such applications may or may not involve immersive experiences. The following use case provides an example of such use case or scenario in which a user has created a personal avatar asset that closely approximates his or her appearance in the real world for use in an example real-world online application other than a virtual world platform.

In this example use case, a user, as a virtual or digital asset, may have created a “selfie” avatar (e.g., from imagery captured from a mobile camera device, or miniature camera array, or other capturing devices, which are subsequently synthesized into one or more predefined 3D formats). The user may store his or her avatar into a 3D personalized asset locker. An online retail application for a clothing store may accepts the user's avatar into a virtual dressing or fitting room in which the user can try on different styles of clothing in different virtual environments (e.g., in a night club, restaurant, or in a sporting activity) and in different lighting and shading conditions. The virtual dressing room allows the user to visualize the different style of clothing on his or her person and in different environments, thereby providing information relevant to the user's decision on whether or not to purchase the clothing.

In some implementations, after the application receives the personalized digital asset (e.g., avatar), it may first modify or vary the personalized digital asset in order to adapt the personalized digital asset to the digital asset in the application, so that these digital assets can be combined with desired consistency for rendering. For example, the size of the personalized digital asset may be modified. Color or color pallet of the personalized digital asset may be modified. In applications involving various different types of personalized digital assets, the modification and adaptation above may include but is not limited to: rounding corners and/or edges in the personalized digital assets so that they are consistent with the digital assets in the application (e.g., with rounded corners/edges), changing overall local geometry of the personalized digital assets to be consistent with the digital assets in the applications, size modification, adaptation or modification of color themes, and the like. As such, even though the personalized digital assets are managed and distributed by the trusted service provider, they are configured to be modifiable or adaptable by the authorized applications. For example, the applications may be specifically authorized by the user in order to modify/adapt the personalized digital assets. In some implementations, the right to modify/adapt may be associated with or attached the Personalized digital assets, and provisioned, again, using one or more digital right management schemes to the applications.

In some example implementations, the adaptation or modification above for the personalized digital assets may be performed by the applications (e.g., with authorization and right to modify/adapt). Alternatively, such modification may be requested by the application and performed by the trusted service provider in the trusted environment before the trusted service provider delivers the modified/adapted personalized digital asset to the applications. The applications may specify the types of modification or adaptation in their requests for the personalized digital assets.

Considering the above use case, the following description provides a list including example features that may be implemented in order to facilitate such a use case in a user acceptable manner:
1. The user owns and controls the usage and digital rights for his or her own digital avatar asset(s). Such digital avatar asset(s) or any other such digital assets should be protected using one or more digital right management technologies in order to prevent these digital assets from unauthorized duplication, transmission, reception, decoding, and display, or any other unpermitted usage.
2. A third-party provides a trusted service (i.e., the 3D asset locker described above) to the user in which the user's avatar is stored and securely protected from theft or other fraudulent activity. This trusted service feature may be similar but is not limited to how cloud storage service providers use for providing storage services through which users may store copies of their digital items (e.g., photographs, documents, videos, backups of their application data).
3. Upon entering the online portal for the retail application, the user may grant the application access to his or her avatar that is stored by the trusted third-party service (e.g., the “3D asset locker” described in this use case) from which the application may download, stream, or otherwise access the user's avatar assets. More explicitly, the retail application may obtain an authorized copy of the digital asset directly from the user's digital locker described in item 2 above, through a transaction that protects the security of the user's digital asset.
4. The online retail application may access its own database of clothing products and applies the digitized and/or virtualized versions of the user-selected clothing items to the user's avatar. This action of applying the clothing items to the user's avatar may be achieved by compositing the user's digital avatar with the digital representations of the clothing items, and rendering in real time the composited result. Hence the rendered result provides an appearance of the user's avatar being clothed with the selected clothing item(s) in a virtual manner.
5. The user may be able to manipulate a camera in the online scene (i.e., the “virtual dressing room”) to view the selected clothing items as applied to his or her avatar. This feature may be achieved by enabling the user to direct a virtual camera that is focused into the scene (i.e., the virtual dressing room) through the use of a real-time renderer.
6. The user should be able to change the environment of the scene such that the virtual dressing room is converted into other environments with different lighting conditions, e.g., outdoor sun, indoor ambient lighting, spot lights, bars, restaurants, concert halls, and the like. This enables the user to consider the apparel selections in different lighting scenarios and environment in a virtual manner.
7. Upon the completion of the online retail session, the user may or may not choose to allow the retail application to save a copy of the combined clothing and avatar assets for viewing in a subsequent session. Such permission, storage, and subsequent viewing, again, may be provisioned by the application itself under user authorization or by the trusted third-party using encryption and digital right management techniques.

Further in the above example scenario, the digital assets such as user's selfie avatar may be personalized and managed and provided by the trusted third-party service. Such third-party service may provide multiple features to facilitate the online retail experiences (e.g., of trying and buying clothes) between the user client and the retail application provider. Some of these features may include but are not limited to:
1. A secure and private storage for the user's personalized digital assets.
2. The ability for the user to authorize the retail service provider to access one or more of the user's digital assets.
3. The ability to authenticate that the retail service provider has permission to access one or more of the user's digital assets.
4. The ability to encrypt information into each user asset to restrict usage of each asset such that it may be used by only the user-designated retailer.
5. The ability to securely download or stream the asset(s) to the retailer.
6. The ability to ensure that the transactions between the trusted third-party service and the retailer are secure.
7. The ability to protect the personalized digital assets of the user such that an application that is authorized to use a particular digital assess cannot possibly or easily retain a permanent copy locally; duplicate the digital assets, and retransmit the digital assets elsewhere unless specifically authorized by the user.

The virtual online clothes store above may or may not involve immersive experiences. For non-immersive implementations, for example, the user's avatar with clothes being tried on in user specified environment may be displayed in any display device (e.g., flat panel display device) for the user to watch, to manipulate (viewing angle, lighting condition, etc.) and evaluate. For an immersive implementation, the user may observe his own avatar wearing clothes of choice in the selected environment and lighting condition in a virtual reality (VR) manner using, for example, VR equipment.

The use case for the personalized virtual digital assets may not be limited to the example application of virtually trying out and buying clothes in online above, or to online retail application in general. Further, the personalized virtual digital assets being used in various application may not be limited to a particular version of avatar (full body avatar, half body avatar, etc.), or may not be limited to avatar assets at all.

In a further extension of the online clothes store application, the clothes purchased by a user may be separately mailed (physically) to the user. In addition, by the nature of the virtual purchasing activity, a digital version of the clothes being purchased may also accompany the transaction and may be delivered to the user and may become a personal digital asset. Such a digital asset may be managed by the retailer. Alternatively, such a digital asset may be managed by the trusted third-party service provider on behalf of the retailer. Furthermore, once becoming a personal asset, the digital version of the clothes purchased by the user may be imported and included in the user's wardrobe in the virtual world and used in a virtual world platform (e.g., worn by the avatar of the user) when interacting with other avatars in the virtual world environment in any independent virtual world platforms, provided that such digital assets are constructed in a standardized format.

In the example implementation and use case above, the various digital assets as managed by trusted third-party service provider may be truly virtualized and used in applications that are close to real-world, within or across virtual world platforms, and also bridge between real-world applications and virtual world platforms.

The personalized digital assets above may be developed toward the general goal of providing these personalized digital assets in a unified and holistic manner to within and across virtual world immersive experiences, e.g., potentially consistent with ideas for a Metaverse or a virtual world, and other applications less about virtual worlds (such the retail clothes application). The recording and management of such personal asset provenance, usage rights, and transfer of ownership are critical. In some example implementations, unlike non-fungible tokens (NFTs) that exist on a blockchain, such user-owned assets may be stored apart from a blockchain, e.g., by a trusted storage service provider, thereby enabling the replication and or distribution of assets entrusted by the third party to do so while preventing other applications from such distribution and duplication via digital right management techniques.

In some example implementations, the provisioning of such digital assets may be partially outside of block-chain and partially with block-chain. For example, the storage of the assets by the trusted third-party service provider may be done off-block chain such that in order for enable duplication and distribution of the digital assets by the trusted service provider. The distribution of a copy of the digital asset to a retailer application, for example, may be implemented in a blockchain, so that further duplication and distribution can be prevented.

In the applications above involving the personalized digital assets, such as the digital avatar, the experience, either immersive or non-immersive, may be rendered in various manners. In the additional disclosure below, the term “renderer” may be used to broadly refer to any device for generation and synthesis of output for user perception. In the context of immersive experience, the term “renderer” may be used to refer to a (typically software-based) application or process, based on a selective mixture of disciplines related to: acoustic physics, light physics, visual perception, audio perception, mathematics, and software development, that, given an input scene graph and asset container, emits a typically visual and/or audio signal suitable for presentation on a targeted device or conforming to the desired properties as specified by attributes of a render target node in the scene graph. Accordingly, for visual-based media assets, a renderer may emit a visual signal suitable for a targeted display, or for storage as an intermediate asset (e.g., repackaged into another container or used in a series of rendering processes in a graphics pipeline). For audio-based media assets, a renderer may emit an audio signal for presentation in a multi-channel loudspeaker and/or binaural headphones, or for repackaging into another (output) container. Popular examples of renderers include the real-time rendering features of the game engines Unity and Unreal Engine. For example, a number of immersive media-capable devices may be implemented, including head-mounted displays, augmented-reality glasses, hand-held controllers, multi-view displays, haptic gloves, and game consoles.

The further disclosure below addresses the need for a trusted service that exists as and is provided by a third-party entity between a user and one or more separate and distinct applications (including virtual world applications and/or other real-world applications). Such a trusted service may exist in a network managed by an Internet Service Provider or by a Cloud Storage Service Provider. The primary role of the trusted service is to provide secure online storage and distribution of user-created digital assets to the one or more applications whereby the distribution of said assets is at the authenticated direction of the user and protected via, for example, digital right management schemes.

As such, the trusted service may leverage a number of data encryption algorithms and other security mechanisms or protocols within or outside of one or more digital right management schemes to secure the networked transactions between the authenticated owner of the assets and the application resulting in the secure network distribution of the identified assets to the application for use by only applications authorized by the user, i.e., the assets may not be shared or distributed beyond the specific instances authorized by the user, and/or may not be duplicated and redistributed by the application unless further authorized by the user.

For example, the distribution of a personalized digital assets may be accompanied by a usage right restriction provisioned by one or more digital right management schemes. In some example implementations, the usage right restriction may be configured and provisioned to prohibit a duplication of the distributed personalized digital asset or a redistribution of the personalized digital asset to other applications. In some example implementations, distributing the personal digital asset is performed in the blockchain system for such prohibition. In some example implementations, the usage right restriction may be configured or provision led to enforce a usage time expiration condition of the distributed personalized digital asset. For example, the usage right may expire at the end of a communication session, or after a configured amount of time.

A single user digital asset as provisioned by the third-party service provider may be of any form that is understood and by both the third-party service provider and the applications, and is thus renderable by the applications. In the example implementations in the disclosure herein, it is assumed, without loss of generality, that a single user asset may exist in a number of example formats. As one example, a user avatar may be stored in the Graphics Language Transmission Format (glTF) version 2.0 by Khronos, Universal Scene Description (USD) format by Pixar, or Immersive Technologies Media Format (ITMF) by the Immersive Digital Experiences Alliance (IDEA). Likewise, the avatar may represent a true-to-life likeness of the user (as generated, for example, via the manner described above), or may be designed to represent the user in another persona, e.g., for one or more gaming platforms or virtual worlds.

In some example implementations, the third-parity trusted service provider may be an internet service provider of the user. As such, when the user signs in or login to the internet service, he or she may be directly authorized to use the trusted service of provisioning of his or her personalized digital assets including his or her avatar.

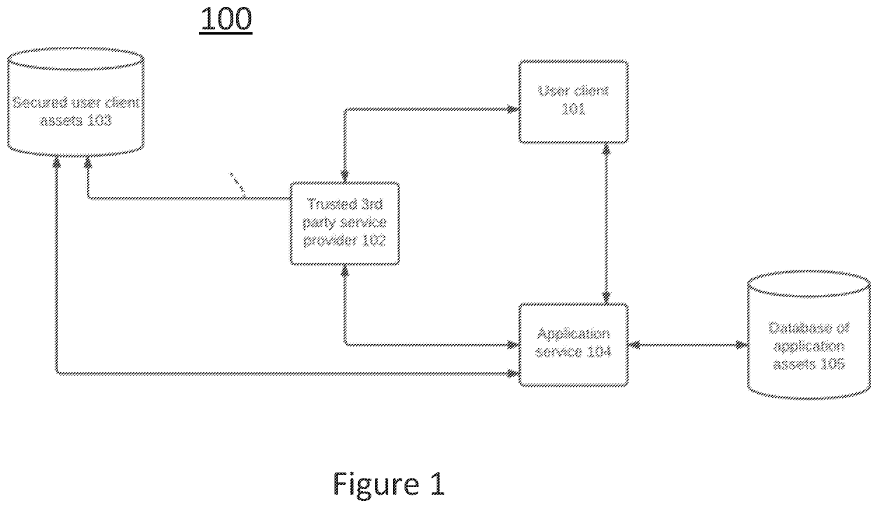

An example implementation of the personalized digital assets management and utilization system following the principles described above is illustrated FIG. 1 which depicts a relationship diagram 100 between various entities and their processing circuitry. User Client 101 represents a client application running on a client device. The client device may be implemented as any electronic device that is capable of processing and render information and media contents. For example, the client device may be equipped with a 3D immersive display as well as sensors and circuitry for obtaining user input. User personalized digital assets are stored in the Secured user client assets storage circuitry 103. Such a storage is managed and provisioned by the trusted third-party Service circuitry 102, which provides secure access to the Secured User Assets 103. Application Service Provider circuitry 104 manages the experience for the specific application (e.g., the example online clothes retail described above, or other immersive or non-immersive applications). Application Asset database 105 contain digital assets that are owned by the Application Service Provider circuitry 104 and may be used to create the user experience (such as the settings associated with the virtual dressing room and the digitized version of the clothing item in the virtual dressing room use case described above). For the example application above that provides online clothes retail virtual dressing room, such digital assets may represent the digitized version of the clothes items being sold. Such digital assets may be specific to the application and thus may be provisioned by the application in its own data base 105. Alternatively, some of such assets belonging to the Application Service Provider may be created by the Application Provider but managed as personalized assets by the Trusted 3rd party service provider circuitry 102 as part of the secured user client assets storage 103. Those type of assets may follow standard format such that they may be used across applications and platforms. An example of such assets may be the digitalization of the clothing items in the virtual dressing room use case described above, which may be worn by a purchasing user's avatar in other applications or virtual world platforms. While the various objects in FIG. 1 refers to the entities involved in the provisioning of the personalized digital assets of the user, these objects are also intended to represent the processing circuitry associated with these entities.

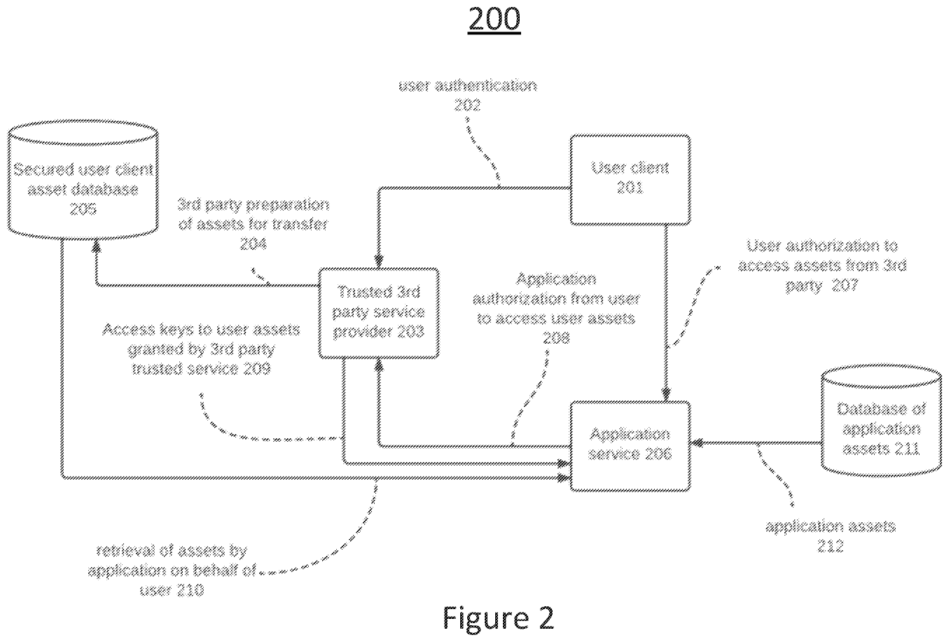

FIG. 2 further depicts a data flow diagram 200 for interactions in which the secured assets are transferred to an application on behalf of the user in the personalized digital assets management and utilization system 100 of FIG. 1. As shown in FIG. 2, the User Client 201 (corresponding to 101 of FIG. 1) and its underlying circuitry may initiate a User Authentication request 202 to the Trusted 3rd Party Service Provider 203 (corresponding to 102 of FIG. 1). The User Client 201 may also communicate a User Authorization 207 (referred to as User Authorization to access assets) to the Application Service Provider 206 (corresponding to 104 of FIG. 1), in the form of one or more secure request messages. The Application Service Provider 206 may send an Application Authorization 208 (referred to as Application Authorization from User to Access User Assets) to the trusted Service Provider 203 (corresponding to 104 of FIG. 1). The trusted Service Provider 203 may then initiate a Preparation process 204 (referred to as Preparation of Assets for Transfer) with the Secured User Client Asset Database 205 (corresponding to 103 of FIG. 1) in order to access the requested personalized digital assets. The Application Service Provider 206 then initiates Retrieval process 210 (referred to as retrieval of Assets on Behalf of User) to obtain the personalized digital assets authorized by the user client 201 from the secured user client asset database 205. Optionally, the Application Service Provider 206 may further perform a retrieval process to retrieves Application Assets 212 from Database of Application Assets 211 (corresponding to 105 of FIG. 1) in order to provide request application/experience by the user. As described above but not explicitly shown in FIG. 2, digital assets belong to the application, such as the digital assets of database 211 may also be provided by the Application service 206 for storage in the Secured user client asset database 205 via the trusted service provider 203 such that these assets can be used across applications and platforms.

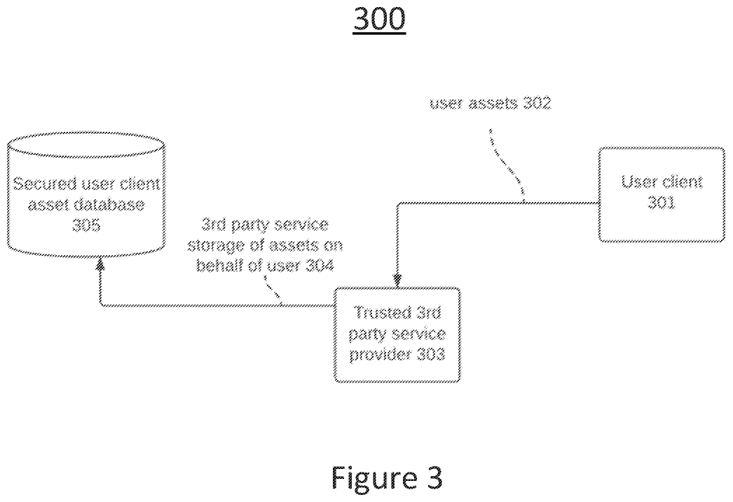

FIG. 3 depicts a data flow diagram 300 for a transaction in which the secured assets are transferred to the Secured User Client Database during personalized digital assets creation and storage process. The User Client 301 (corresponding to 101 of FIG. 1 above) may generate User Assets 302 as described above and initiate a transfer of the User Assets 302 to the Trusted 3rd Party Service Provider 303 (corresponding to 102 of FIG. 1 above). In response, the Service Provider 303 may initiate a storage request 304 to the Secured User Client Asset Database 305 (corresponding to 103 of FIG. 1 above).

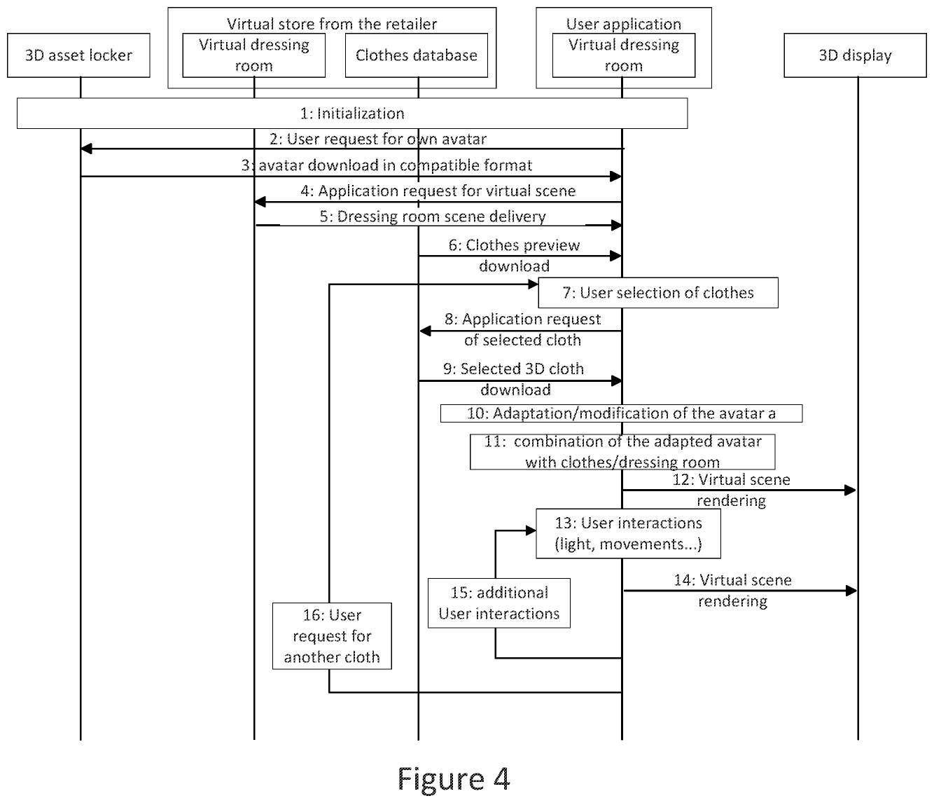

FIG. 4 depicts an example sequence of interactions/messaging in the context of the virtual dressing room use case described above. In this example sequence and interactions/messaging of FIG. 4, the trusted service is identified and referred to as a “3D asset locker”. The application service is identified as “Virtual store from the retailer” on the application service provider side. The user client is identified as “user application”. The rendering device on the user client side is identified as “3D display” (merely as an example, the display need not be a 3D display). Example steps of this example sequence may include but are not limited to the following.
1. The initialization step is performed. The initialization step includes application initialization, user authentication, discovery, and connection to the 3D asset locker, virtual dressing room and clothes database, including format negotiation and determination.
2. The user selects his/her own personalized avatar from the 3D asset locker.
3. The selected avatar is downloaded in a format supported by the application.
4. The application selects the virtual room from the retailer database.
5. The selected virtual room is delivered to the application in a compliant format.
6. A preview of the available clothes in the database is sent to the application.
7. The user selects an item of clothing to try in the virtual room in the user application client.
8. The application requests the chosen item of clothing from the Clothes database.
9. The selected clothing item is sent to the application in a compliant format.
10. The received avatar may be modified or adapted according to need and user authorization (as provisioned by the trusted service provider) by the user application in order combine the avatar with the digital versions of the closes in the virtual dressing room. Example modification or adaptation were described above. The modification or adaptation may alternatively be performed by the trusted service provider (3D asset locker) according to request from the application and/or user authorization.
11. The application combines the selected clothing item and the avatar (e.g., the modified or adapted avatar from step 10) and places the combination in the virtual dressing room.
12. The display at the user client side is rendered, e.g., in a 3D format, from a default viewpoint.
13. The user interacts with the scene (e.g., moving the avatar in the room, selecting a different viewpoint, changing the lighting condition and environment settings, and the like).
14. The updated scene is rendered at the user client side in real-time from the new viewpoint.
15. Return to Step 13 as long as the user interacts with the scene
16. Return to Step 7 if the user selects another item of clothing to try.

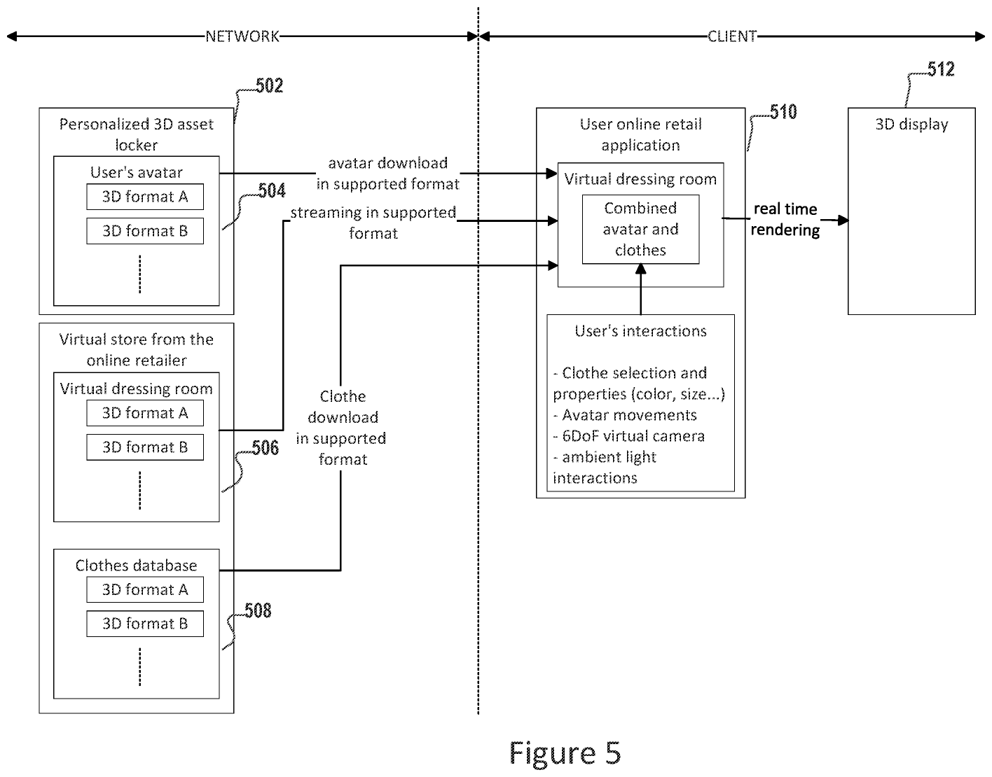

FIG. 5 further shows a diagram for functional entities for the example virtual dressing room use case described above in FIG. 4. As shown in FIG. 5, the personalized 3D asset locker 502 is provided by the trusted third-party service provider and is configured to store personalized digital assets such as personal avatars and to deliver the personalized digital assets in appropriate requested formats when authorized. The virtual store associated with the online retailer, labeled as 504, contains digital assets (e.g., 3D digital assets) owned by the retailer including one or more virtual dressing rooms 506, and a clothes database 508 that includes a set of 3D assets (e.g., digitized 3D version of the clothing items) to be browsed and selected by the user. The one or more virtual rooms 506 may be configured into different context or environment with different lighting conditions, which may be selectively determined by user selection and navigation. The client side User application 510 (the client side of the user online retail application for the particular virtual online dressing room use case) may be configured to download the 3D assets (such as user's avatar, from the personized 3D asset locker 502), the virtual dressing room and clothes items from the virtual store 504, and combine them depending on the user's interactions (selection of clothes, navigation in the virtual room, setting selection of the virtual room), and to finally send the view for rendering in, e.g., the 3D display 512.

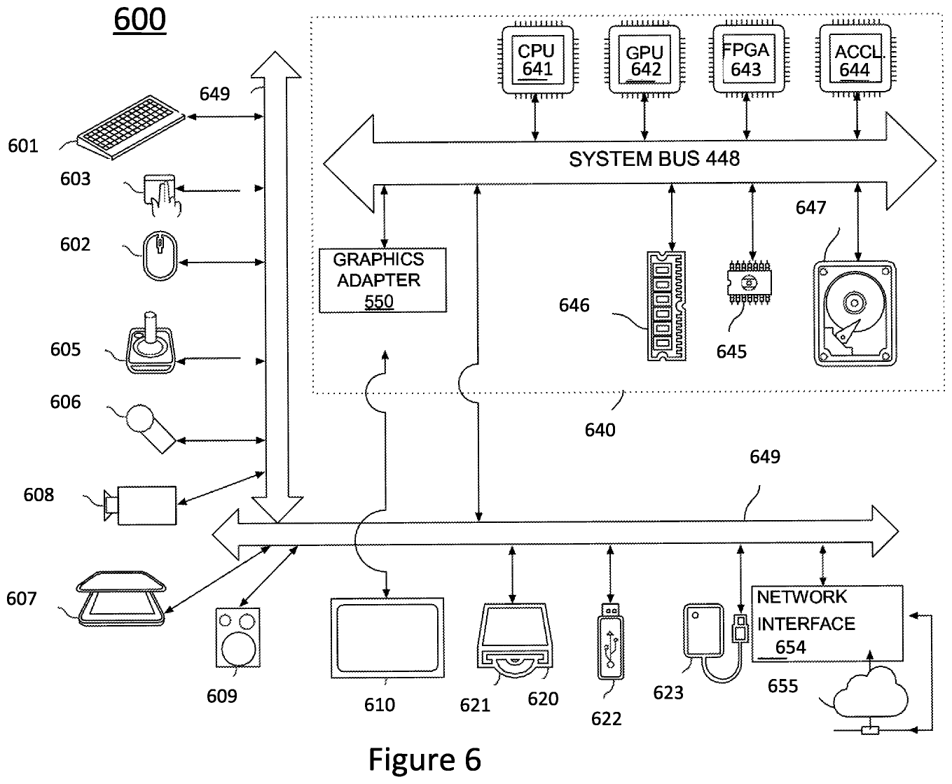

Each of functions above may be implemented by a circuitry, which may be a dedicated circuitry or may be implemented by a general computing device. These computing devices may be centralized or distributed physical machines (e.g., personal computers, tablet computers, servers, smartphones, personal digital assistance devices, wearable devices, gaming devices, internet of things devices, and the like) or virtualize versions of computing machines implemented, e.g., in a cloud platform, with underlying distributed physical computers and storages. FIG. 6 shows an example of such computing system with example components that may be included in each of the dedicated or virtual computer systems that may be used for the example personalized asset implementations above by running a set of computer software. Such computer software can be coded using any suitable machine code or computer language, that may be subject to assembly, compilation, linking, or like mechanisms to create code comprising instructions that can be executed directly, or through interpretation, micro-code execution, and the like, by computer central processing units (CPUs), Graphics Processing Units (GPUs), and the like as included in the computing system.

The components shown in FIG. 6 for computer system 600 are exemplary in nature and are not intended to suggest any limitation as to the scope of use or functionality of the computer software implementing embodiments of the present disclosure. Neither should the configuration of components be interpreted as having any dependency or requirement relating to any one or combination of components illustrated in the exemplary embodiment of a computer system 600.

Computer system 600 may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices can also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard 601, mouse 602, trackpad 603, touch screen 610, data-glove (not depicted), joystick 605, microphone 606, scanner 607, camera 608.

Computer system 600 may also include certain human interface output devices. Such human interface output devices may be stimulating the senses of one or more human users through, for example, tactile output, sound, light, and smell/taste. Such human interface output devices may include tactile output devices (for example tactile feedback by the touch-screen 610, data-glove (not depicted), or joystick 605, but there can also be tactile feedback devices that do not serve as input devices), audio output devices (such as: speakers 609, headphones (not depicted)), visual output devices (such as screens 610 to include CRT screens, LCD screens, plasma screens, OLED screens, each with or without touch-screen input capability, each with or without tactile feedback capability-some of which may be capable to output two dimensional visual output or more than three dimensional output through means such as stereographic output; virtual-reality glasses (not depicted), holographic displays and smoke tanks (not depicted)), and printers (not depicted).

Computer system 600 can also include human accessible storage devices and their associated media such as optical media including CD/DVD ROM/RW 620 with CD/DVD or the like media 621, thumb-drive 622, removable hard drive or solid-state drive 623, legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system 600 can also include interface to one or more communication networks. Networks can for example be wireless, wireline, optical. Networks can further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general-purpose data ports or peripheral buses (649) (such as, for example USB ports of the computer system 600; others are commonly integrated into the core of the computer system 600 by attachment to a system bus as described below (for example Ethernet interface into a PC computer system or cellular network interface into a smartphone computer system). Using any of these networks, computer system 600 can communicate with other entities. Such communication can be uni-directional, receive only (for example, broadcast TV), uni-directional send-only (for example CANbus to certain CANbus devices), or bi-directional, for example to other computer systems using local or wide area digital networks. Certain protocols and protocol stacks can be used on each of those networks and network interfaces as described above.

Aforementioned human interface devices, human-accessible storage devices, and network interfaces can be attached to a core 640 of the computer system 600.

The core 640 can include one or more Central Processing Units (CPU) 641, Graphics Processing Units (GPU) 642, specialized programmable processing units in the form of Field Programmable Gate Areas (FPGA) 643, hardware accelerators for certain tasks 644, and so forth. These devices, along with Read-only memory (ROM) 645, Random-access memory 646, internal mass storage such as internal non-user accessible hard drives, SSDs, and the like 647, may be connected through a system bus 648. In some computer systems, the system bus 648 can be accessible in the form of one or more physical plugs to enable extensions by additional CPUs, GPU, and the like. The peripheral devices can be attached either directly to the core's system bus 648, or through a peripheral bus 649. Architectures for a peripheral bus include PCI, USB, and the like.

CPUs 641, GPUs 642, FPGAs 643, and accelerators 644 can execute certain instructions that, in combination, can make up the aforementioned computer code. That computer code can be stored in ROM 645 or RAM 646. Transitional data can be also be stored in RAM 646, whereas permanent data can be stored for example, in the internal mass storage 647. Fast storage and retrieve to any of the memory devices can be enabled through the use of cache memory, that can be closely associated with one or more CPU 641, GPU 642, mass storage 647, ROM 645, RAM 646, and the like.

The computer readable media can have computer code thereon for performing various computer-implemented operations. The media and computer code can be those specially designed and constructed for the purposes of the present disclosure, or they can be of the kind well known and available to those having skill in the computer software arts.

As an example and not by way of limitation, the computer system having architecture 600, and specifically the core 640 can provide functionality as a result of processor(s) (including CPUs, GPUs, FPGA, accelerators, and the like) executing software embodied in one or more tangible, computer-readable media. Such computer-readable media can be media associated with user-accessible mass storage as introduced above, as well as certain storage of the core 640 that are of non-transitory nature, such as core-internal mass storage 647 or ROM 645. The software implementing various embodiments of the present disclosure can be stored in such devices and executed by core 640. A computer-readable medium can include one or more memory devices or chips, according to particular needs. The software can cause the core 640 and specifically the processors therein (including CPU, GPU, FPGA, and the like) to execute particular processes or particular parts of particular processes described herein, including defining data structures stored in RAM 646 and modifying such data structures according to the processes defined by the software. In addition or as an alternative, the computer system can provide functionality as a result of logic hardwired or otherwise embodied in a circuit (for example: accelerator 644), which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

What is claimed is:

1. A method for providing a personalized digital asset as a service by a trusted circuitry to a heterogenous set of independent applications:
receiving the personalized digital asset generated in a common format;
storing the personalized digital asset off a blockchain system; and
distributing the personalized digital asset with a usage right restriction and right to modify or adapt to any application among the heterogenous set of independent applications when the personalized digital asset is requested by the application and is electronically authorized by an owner of the personalized digital asset, the usage right restriction being provisioned under at least one digital right management scheme.

2. The method of claim 1, wherein the personalized digital asset comprise an 3D avatar created by the owner.

3. The method of claim 1, wherein the usage right restriction is configured to prohibit a duplication of the distributed personalized digital asset or a redistribution of the personalized digital asset to other applications.

4. The method of claim 3, wherein distributing the personal digital asset is performed in the blockchain system.

5. The method of claim 1, wherein the usage right restriction is configured to enforce a usage time expiration condition of the distributed personalized digital asset.

6. The method of claim 1, further comprises:
receiving an augmenting digital asset that is combinable with the personalized digital asset, the augmenting digital asset being provided by the application for augmenting the personal digital asset; and
storing the augmenting digital asset off the blockchain system.

7. The method of claim 6, further comprising providing the augmenting digital asset for combination with the personalized digital asset for usage in another application among the heterogenous set of independent applications.

8. The method of claim 1, wherein the application is an online retail store comprising a virtual dressing room and 3D digitization of a plurality of items being sold.

9. The method of claim 1, wherein the application is an online retail store, and the method further comprising:
distributing the personalized digital asset to a second application among the heterogenous set of independent applications when the personalized digital asset is requested by the second application and is electronically authorized by the owner of the personalized digital asset, the second application being a virtual world application.

10. The method of claim 1, wherein:
the heterogeneous set of independent applications comprise at least one real-world application and at least one virtual world application; and
the personalized digital asset is provisioned by the trusted circuitry to both the at least one real-world application and the at least one virtual world application.

11. The method of claim 1, wherein:
the heterogeneous set of independent applications comprise at least two distinct virtual world applications; and
the personalized digital asset is provisioned by the trusted circuitry for use in both of the at least two distinct virtual world applications.

12. A system for providing a personalized digital asset as a service by a trusted circuitry to a heterogenous set of independent applications, the system comprising a memory for storing computer instructions and a processor configured to execute the computer instructions to:
receive the personalized digital asset generated in a common format;
store the personalized digital asset off a blockchain system; and
distribute the personalized digital asset with a usage right restriction and right to modify or adapt to any application among the heterogenous set of independent applications when the personalized digital asset is requested by the application and is electronically authorized by an owner of the personalized digital asset, the usage right restriction being provisioned under at least one digital right management scheme.

13. The system of claim 12, wherein the personalized digital asset comprise an 3D avatar created by the owner.

14. The system of claim 12, wherein the usage right restriction is configured to prohibit a duplication of the distributed personalized digital asset or a redistribution of the personalized digital asset to other application.

15. The system of claim 14, wherein distributing the personalized digital asset is performed in the blockchain system.

16. The system of claim 12, wherein the usage right restriction is configured to enforce a usage time expiration condition of the distributed personalized digital asset.

17. The system of claim 12, wherein the processor is further configured to execute the computer instructions to:
receive an augmenting digital asset that is combinable with the personalized digital asset, the augmenting digital asset being provided by the application for augmenting the personal digital asset; and
store the augmenting digital asset off the blockchain system.

18. The system of claim 17, wherein the processor is further configured to execute the computer instructions to provide the augmenting digital asset for combination with the personalized digital asset for usage in another application among the heterogenous set of independent applications.

19. The system of claim 13, wherein the application is an online retail store, and the processor is further configured to execute the computer instructions to:
distributing the personalized digital asset to a second application among the heterogenous set of independent applications when the personalized digital asset is requested by the second application and is electronically authorized by the owner of the personalized digital asset, the second application being a virtual world application.

20. A non-transitory computer-readable medium for storing computer instructions, the computer instructions, when executed by a circuitry for providing a personalized digital asset as a service by a trusted circuitry to a heterogenous set of independent applications, are configured to:
receive the personalized digital asset generated in a common format;
store the personalized digital asset off a blockchain system; and
distribute the personalized digital asset with a usage right restriction and right to modify or adapt to any application among the heterogenous set of independent applications when the personalized digital asset is requested by the application and is electronically authorized by an owner of the personalized digital asset, the usage right restriction being provisioned under at least one digital right management scheme.
